(19) United States
(12) Patent Application Publication
(10) Pub. No.: US 2025/0378600 A1
(43) Pub. Date: Dec. 11, 2025

(54) PHYSICALLY BASED INVERSE RENDERING (IR) FOR IMAGE RECONSTRUCTION

(71) Applicant: CORNELL UNIVERSITY, Ithaca, NY (US)

(72) Inventors: Amirhossein Goldan, New York, NY (US); Zipai Wang, New York, NY (US); Yixin Li, New York, NY (US); Wenzel Jakob, New York, NY (US)

(73) Assignee: CORNELL UNIVERSITY, Ithaca, NY (US)

(21) Appl. No.: 19/231,216

(22) Filed: Jun. 6, 2025

Related U.S. Application Data
(60) Provisional application No. 63/657,559, filed on Jun. 7, 2024.
(60) Provisional application No. 63/713,463, filed on Oct. 29, 2024.
(60) Provisional application No. 63/717,646, filed on Nov. 7, 2024.

(51) Int. Cl. G06T 11/00; G06T 7/00

(52) U.S. Cl. CPC G06T 11/006; G06T 7/0012; G06T 11/005; G06T 11/008; G06T 2207/10104; G06T 2207/30016; G06T 2210/41; G06T 2211/424; G06T 2211/452

(57) ABSTRACT

The present disclosure relates to reconstructing positron emission tomography (PET) images. The approach may involve receiving measured sinogram data from one or more scans by a PET scanner. The measured sinogram data may represent measured projections from the PET scanner. The approach may involve performing forward rendering to generate a rendered sinogram. Forward rendering may comprise sampling a number of positions corresponding to each crystal detector in a plurality of crystal detectors. The positions may define lines of response (LORs) between crystal pairs. The approach may involve performing inverse rendering based on the measured sinogram data and the rendered sinogram. Inverse rendering may comprise applying auto-differentiation for gradient-based optimization. The rendering may be performed iteratively to update pixel values of an emission image until a stopping criterion. A reconstructed PET image based on the updated emission image may be output following the stopping criterion being satisfied.

### CROSS-REFERENCE TO RELATED APPLICATIONS

This application claims priority to and the benefit of U.S. Provisional Patent Application No. 63/717,646 filed Nov. 7, 2024, U.S. Provisional Patent Application No. 63/713,463 filed Oct. 29, 2024, and U.S. Provisional Patent Application No. 63/657,559 filed Jun. 7, 2024, each of which is incorporated herein by reference in its entirety.

### BACKGROUND

Positron Emission Tomography (PET) is a powerful nuclear imaging modality that enables the visualization and quantification of physiological processes at the molecular level. In PET imaging, a radiotracer labeled with a positron-emitting isotope is administered to a subject. As the isotope decays, it emits positrons that annihilate with electrons, producing pairs of gamma photons traveling in opposite directions. These photons are detected by a ring of detectors surrounding the subject, generating raw coincidence data known as sinograms. Image reconstruction in PET refers to the transformation of raw sinogram data into interpretable cross-sectional images that represent the spatial distribution of the radiotracer within the body. This process is inherently complex due to the stochastic nature of radioactive decay, the limited number of detected events, and the presence of noise and physical effects such as attenuation, scatter, and random coincidences.

### SUMMARY

In one aspect, various embodiments relate to a method for reconstructing positron emission tomography (PET) images using a computing system comprising one or more processors. The method may comprise receiving measured sinogram data from one or more scans by a PET scanner, the measured sinogram data representing measured projections from the PET scanner. The method may comprise updating pixel values of an emission image. The emission image may be iteratively updated until a stopping criterion is satisfied. The method may comprise performing forward rendering to generate a rendered sinogram. Performing forward rendering may comprise sampling a number of positions corresponding to each crystal detector in a plurality of crystal detectors. The positions may define lines of response (LORs) between crystal pairs. The method may comprise performing inverse rendering based on the measured sinogram data and the rendered sinogram. Performing inverse rendering may comprise applying auto-differentiation for gradient-based optimization. The method may comprise outputting a reconstructed PET image based on the updated emission image. The reconstructed PET image may be output following the stopping criterion being satisfied.

In various embodiments, performing forward rendering comprises physics-based modeling of physical processes affecting photon transport. The physical processes may comprise a combination of Compton scatter, attenuation, and/or transmission.

In various embodiments, the method comprises performing a simulation to model physical processes affecting photon transport. The simulation may account for statistical interactions of photons with a medium along each LOR.

In various embodiments, forward rendering comprises randomly sampling multiple points within each crystal detector to define sub-lines of response (sub-LORs).

In various embodiments, inverse rendering comprises point spread function (PSF) modeling.

In various embodiments, inverse rendering comprises adding Gaussian noise to sampled positions to simulate spatial uncertainty in photon detection.

In various embodiments, inverse rendering comprises applying a modified digital differential analyzer (DDA) algorithm. The DDA algorithm may weight voxel intensities according to a Gaussian kernel. The Gaussian kernel may be centered at time-of-flight (TOF).

In various embodiments, inverse rendering comprises minimizing a loss. The loss function may quantify a difference between the rendered sinogram and the measured sinogram data.

In various embodiments, applying auto-differentiation enables simultaneous optimization of a plurality of parameters.

In various embodiments, the method comprises hyper-optimization of voxel intensities and attenuation coefficients.

In various embodiments, the stopping criterion corresponds to minimization of an objective function.

In various embodiments, the stopping criterion corresponds to the rendered sinogram closely matching measured data.

In various embodiments, generating the rendered sinogram comprises integrating contributions from all sub-LORs across all TOF bins.

In various embodiments, each LOR is divided into multiple TOF bins. The TOF bins may be centered symmetrically around a midpoint of the LOR.

In various embodiments, for each bin, performing forward rendering comprises sampling points and evaluating the emission image at sampled points.

In another aspect, various embodiments relate to a computing system comprising one or more processors and being configured to reconstruct positron emission tomography (PET) images. Reconstructing PET images may comprise receiving measured sinogram data from one or more scans by a PET scanner. The measured sinogram data may represent measured projections from the PET scanner. Reconstructing PET images may comprise updating pixel values of an emission image. The emission image may be updated until a stopping criterion is satisfied. Reconstructing PET images may comprise performing forward rendering to generate a rendered sinogram. Performing forward rendering may comprise sampling a number of positions corresponding to each crystal detector in a plurality of crystal detectors. The positions may define lines of response (LORs) between crystal pairs. Reconstructing PET images may comprise performing inverse rendering based on the measured sinogram and the rendered sinogram. Performing inverse rendering may comprise applying auto-differentiation for gradient-based optimization. Reconstructing PET images may comprise outputting a reconstructed PET image based on the updated emission image. The reconstructed PET image may be output following the stopping criterion being satisfied.

In yet another aspect, various embodiments relate to a non-transitory computer-readable storage medium comprising instructions executable by one or more processors of a computing system to reconstruct positron emission tomography (PET). Reconstructing PET images may comprise receiving measured sinogram data from one or more scans by a PET scanner. The measured sinogram data may represent measured projections from the PET scanner. Reconstructing PET images may comprise updating pixel values of an emission image. The emission image may be updated until a stopping criterion is satisfied. Reconstructing PET images may comprise performing forward rendering to generate a rendered sinogram. Performing forward rendering may comprise sampling a number of positions corresponding to each crystal detector in a plurality of crystal detectors. The positions may define lines of response (LORs) between crystal pairs. Reconstructing PET images may comprise performing inverse rendering based on the measured sinogram and the rendered sinogram. Performing inverse rendering may comprise applying auto-differentiation for gradient-based optimization. Reconstructing PET images may comprise outputting a reconstructed PET image based on the updated emission image. The reconstructed PET image may be output following the stopping criterion being satisfied.

### BRIEF DESCRIPTION OF THE DRAWINGS

FIG. 1 depicts an example flow chart of inverse rendering-based image reconstruction, according to various embodiments.

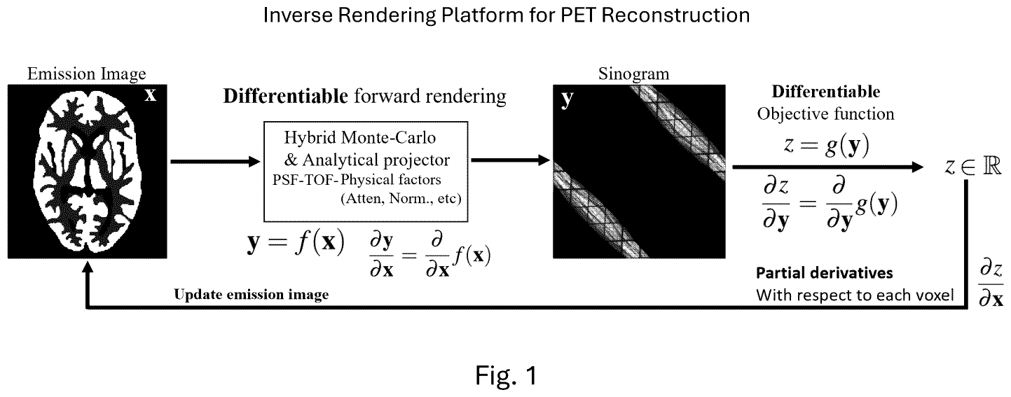

FIG. 2 depicts a schematic of a physically-based inverse rendering image reconstruction model, according to various embodiments.

FIG. 3 depicts reconstructed images of ultra-Micro Derenzo phantoms using GATE simulation data and real experimental data of Data Spectrum, according to various embodiments.

FIG. 4 depicts path tracing of back-to-back gamma without Compton scattering, according to various embodiments.

FIG. 5 depicts Compton scattering of back-to-back gamma, according to various embodiments.

FIG. 6 depicts path tracing of back-to-back gamma with Compton scattering, according to various embodiments.

FIG. 7 depicts an example image reconstruction framework using inverse rendering, according to various embodiments.

FIG. 8 depicts experimental results of PET image reconstruction, according to various embodiments.

FIG. 9 depicts, at (a), a standard digital differential analyzer (DDA) method that follows the lines of response (LORs) through the voxel grid using the exact cell crossing, and at (b), an example of a modified Gaussian DDA (μ=4.5, σ=2), according to various embodiments. Deeper colors indicate higher weights assigned to the voxels.

FIG. 10 depicts, at (a), a reconstructed hotspot image from CASToR, at (b), a reconstructed hotspot image using inverse rendering, and at (c), a line profile of the 1 mm diameter hotspots, according to various embodiments.

FIG. 11 provides, at (a), a clinical result reconstructed using CASToR, and at (b), a clinical result reconstructed using an inverse rendering platform, according to various embodiments.

FIG. 12 depicts an example toolkit for implementing inverse rendering in PET image reconstruction, according to various embodiments. The toolkit “Dr. JIT” may be used at the backend for PET image reconstruction for both standard and differentiable computation.

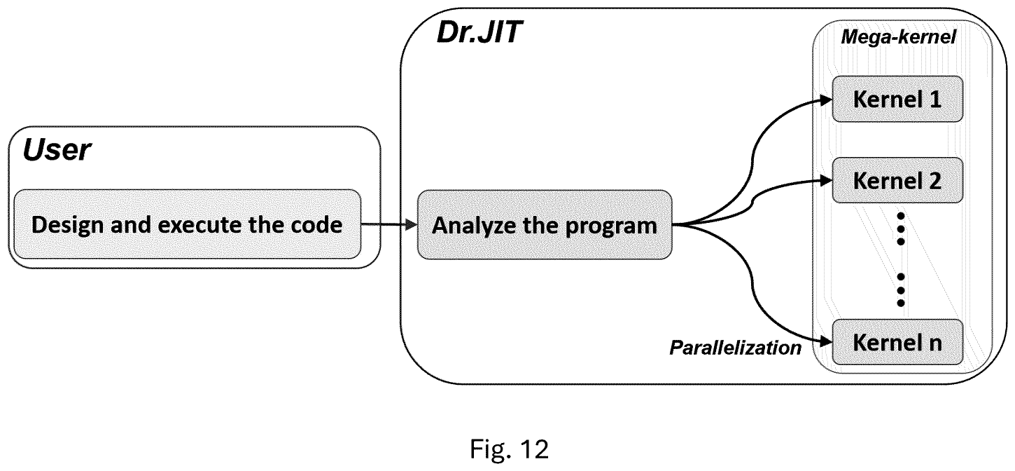

FIG. 13 depicts patient imaging results from three perspectives (transverse, coronal, sagittal) for CASToR reconstruction (top) and inverse rendering reconstruction (bottom), according to various embodiments.

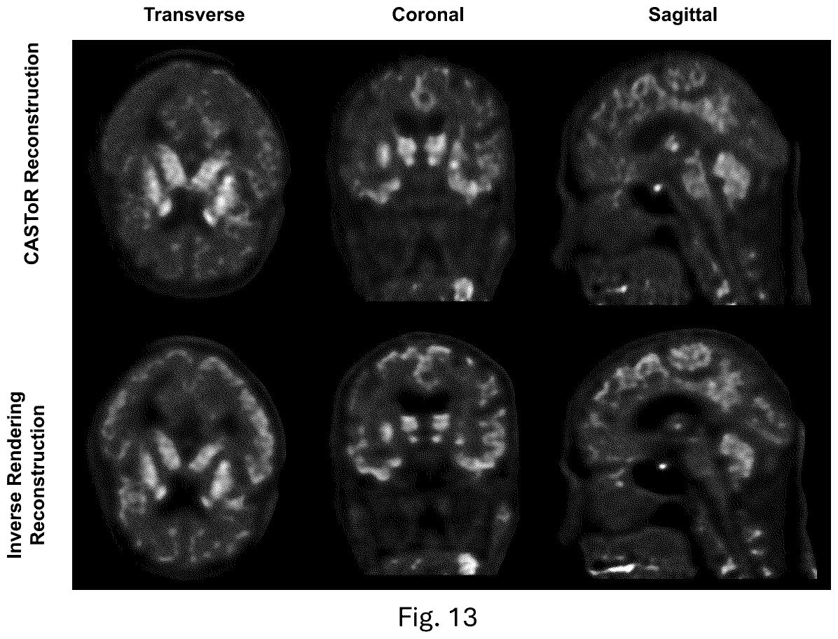

FIG. 14 depicts an example process for implementing various embodiments of the present disclosure.

FIG. 15 depicts a block diagram of a representative networked system and client computer system usable to implement various embodiments of the present disclosure.

### DETAILED DESCRIPTION

Positron Emission Tomography (PET) is an in vivo medical imaging technique that provides images of radiotracer distributions in the body. It is widely used in oncology, neurology, and cardiology for diagnosis, treatment planning, and monitoring. PET imaging involves the detection of gamma photons emitted by the positron-emitting radiotracer administered to the patient. The image reconstruction in PET generates the administered radiotracer's spatial-temporal distribution based on the position and timing of the detected coincident events. The two most common reconstruction algorithms in PET are: 1) the statistical maximum likelihood expectation maximization (MLEM) and 2) learning-based deep learning (DL) techniques. These methods have been extensively studied and improved over the years. However, they still face challenges related to image quality, resolution, and generalization. Specifically, MLEM often struggles with noise, artifacts, partial volume effects, and overfitting problems. On the other hand, DL methods require large amounts of labeled training data and high training costs, cannot be easily generalized across different tracers, and may contain inherent bias if certain patient demographics are underrepresented in the training data.

Differentiable rendering (DR), which leverages the power of graphical processing unit (GPU) clusters for large-scale computing, is an emerging field that facilitates the calculation and propagation of gradients of 3D objects through images. In contrast to deep neural networks (DNNs), which generally lack the understanding of 3D objects that form the image, DR mitigates the need for extensive data collection and annotation, thereby offering a higher success rate across a range of applications.

Embodiments of this disclosure introduce a new frontier in PET image reconstruction based on inverse rendering (IR) which aims to reconstruct the highest resolution image from the measured emission sinogram. In example embodiments, a rendering algorithm takes a 3D scene, represented as a large input vector x, and simulates photons inside it to create a realistic image y=ƒ(x). For the case of PET imaging, IR methods are used to compute the inverse of this process x=ƒ⁻¹(y), meaning that the process may start with the measured sinogram y and invert f to find the matching spatial distribution of emission x. However, solution to this IR problem may be ambiguous and unsolved directly. Physically-based differentiable rendering (PBDR) provides processes that can efficiently differentiate the full process of image formation with respect to millions of parameters (e.g., voxels) to solve such nonlinear IR problems via gradient-based optimization (e.g., gradient descent). This process is very similar to training a neural network except that the computation is a physical simulation instead of a black box. PBDR techniques can iteratively recover complete 3D scenes from sparse images. Although DNNs have shown promise to recover faint signals from noisy PET raw data, which is caused by the limited scan time and/or injected dose, they still rely on massive amounts of data and images reconstructed using the classical MLEM techniques. Thus, the higher resolution IR reconstruction can also enhance deep learning-based methods by providing higher quality training data.

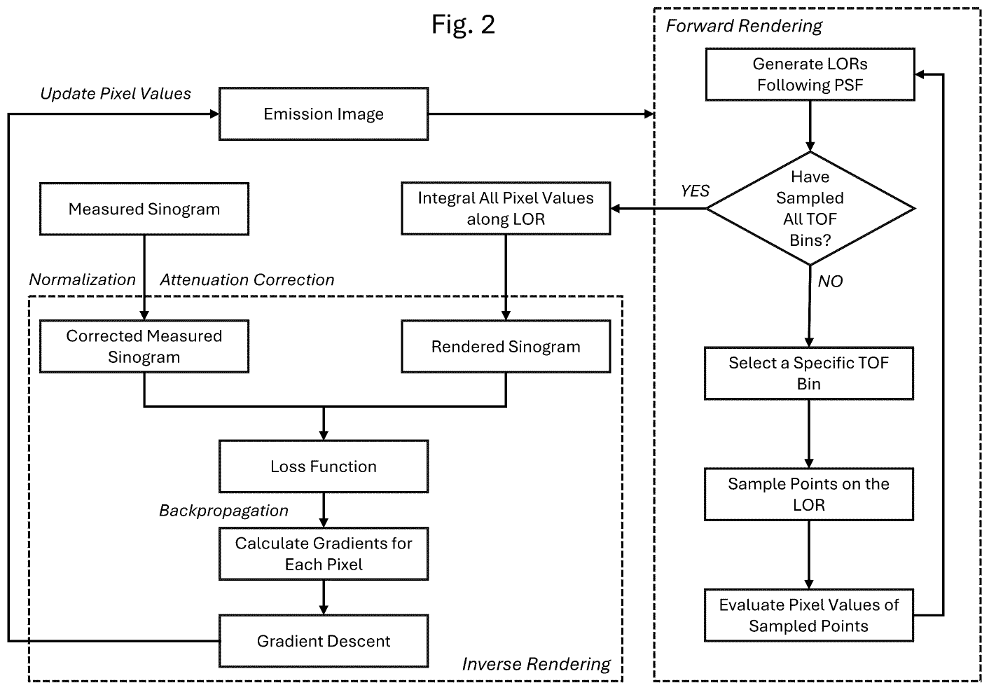

Example embodiments of the disclosed IR reconstruction platform simulates the emission and detection process in PET scanning using two key components: forward rendering and inverse rendering (see, e.g., FIG. 2). The forward rendering process mimics the actual PET scanner by generating the sinogram from the radioactive image. The inverse rendering stage aims to decode underlying information from the sinogram to reconstruct the original radioactive tracer distribution.

In various embodiments, the model begins by creating a 3D zero matrix representing the initial emission image. At the start of the rendering process, we sample a set number of positions within each crystal detector. These positions define the lines of response (LORs) between crystal pairs. For each LOR, we use a Monte Carlo simulation to sample points within each Time-of-Flight (TOF) bin. During this sampling process, each point interacts with the emission image to determine its corresponding pixel value which would be integrated for generating the rendered sinogram.

In various embodiments, an objective function is employed to measure the difference between the rendered sinogram and the actual measured sinogram. Example embodiments leverage backpropagation to calculate the gradient for each pixel in the emission image, which essentially describes how much each pixel's value contributes to the overall discrepancy between the rendered and measured sinograms. Finally, an optimizer algorithm utilizes these gradients to iteratively update the emission image to minimize the objective function, ensuring the rendered sinogram closely resembles the actual measurement.

Forward Rendering: Example embodiments conduct Monte Carlo sampling inside each crystal to sample points representing the positions of gamma-ray interactions. These sampled points then generate LORs between each pair of crystals. In a fully 3D iterative reconstruction process, example embodiments account for the point spread function (PSF) to model the spatial blurring effect introduced by each crystal. In example embodiments, the model assumes that the PSF follows a Gaussian distribution centered at the center of the crystal surface.

$$g ( X , Y , Z ) = {e}^{-} \frac{{X}^{2} + {Y}^{2} + {Z}^{2}}{2 {σ}^{2}} , \qquad ( 1 )$$

where (X, Y, Z)∈ [symbol] ^{N×3} are the spatial coordinates of the center of the N crystals. The standard deviation σ of the Gaussian represents the spatial extent of the blurring, which should be optimized based on the varying sizes of the scintillation crystals within the different detector modules.

Example embodiments consider a PET scanner with a defined radius and length, aligned along the z-axis that defines the axial direction. The plane perpendicular to the axial direction is referred to as a transaxial plane. The function ƒ(x, y, z) represents the three-dimensional distribution of the radioactive tracer on an emission image I. The measured three-dimensional sinogram data can be expressed as p(s, θ, z, δ), which comprises the line integrals of the source distribution ƒ(x, y, z) along each LOR.

$$p ( s , θ , z , δ ) = {\int }_{- ∞}^{∞} f ( s \cdot cos ( θ ) - t \cdot sin ( θ ) , s \cdot sin ( θ ) + t \cdot cos ( θ ) , z + t \cdot δ ) dt . \qquad ( 2 )$$

The LOR for each of the M crystal pairs is specified by (s, θ, z, δ)∈ [symbol] ^{M×4}. s represents the distance between the axial axis and the projection of the line onto a transaxial plane, θ signifies the angle between the projection and the transaxial axis (y-axis), z denotes the axial coordinate of the midpoint between the two detectors of an LOR, and δ represents the tangent of the angle between an LOR and the transaxial plane. Additionally, t denotes the projection of the LOR in the transaxial plane from the axial position z.

When considering TOF during forward rendering, example embodiments divide the LOR into multiple TOF bins, which are symmetrically centered around the midpoint of the LOR. The TOF bins can be represented by the formula below:

$$B = [ {B}_{1} , {B}_{2} , … , {B}_{n} ] , \qquad ( 3 )$$

where B denotes the entire of all TOF bins, comprising n individual bins.

For each TOF bin, example embodiments evaluate the integrand ƒ(x, y, z) at various points within the image domain to estimate the value of its integral along the LOR. According to Eq. (2), example embodiments define the Monte Carlo estimator to approximate the value of an arbitrary integral in TOF bin i as:

$${ℛ}_{i} ( I ) = {p}_{i} ( s , θ , z , δ ) = \frac{1}{m} {\sum }_{j = 1}^{m} {f}_{i} ( s \cdot cos ( θ ) - {t}_{j} \cdot sin ( θ ) , s \cdot sin ( θ ) + {t}_{j} \cdot cos ( θ ) , z + {t}_{j} \cdot δ ) \qquad ( 4 )$$

where m represents the total number of sampling points in each TOF bin. For the total LORs encompassing all TOF bins, the new forward rendering formula is derived as:

$$ℛ ( I ) = [ {ℛ}_{1} ( I ) , {ℛ}_{2} ( I ) , … , {ℛ}_{n} ( I ) ] , \qquad ( 5 )$$

where [symbol] is the forward rendering operator. [symbol] (I) denotes the rendered sinogram.

Prior to conducting the inverse rendering process on the rendered sinogram, we apply data correction to the measured sinogram, including normalization and attenuation correction. The normalization map is generated using the identical geometry configuration, employing a uniform cylinder as the radioactive source to produce a sinogram, thereby accounting for both scanner geometry and crystal efficiency effects. The attenuation correction involves the multiplication of the normalized emission sinogram by the attenuation correction matrix, which is applied to each element within the sinogram.

$$C ( M ) = {p}_{M} ( s , θ , z , δ ) \cdot {p}_{Norm} ( s , θ , z , δ ) \cdot {p}_{AC} ( s , θ , z , δ ) , \qquad ( 6 )$$

where C(M) denotes the measured sinogram post data correction. p_{M}, p_{Norm}, and p_{AC} represent the measured sinogram, normalization and attenuation correction coefficient map, respectively.

Inverse Rendering: In example embodiments, it is important to define an objective function that evaluates the alignment between the rendered sinogram map from the forward rendering function and the actual measured data. The best estimate for the reconstructed image may be obtained by minimizing the loss function:

$$\begin{matrix}\hat{I} = arg min ℒ ( C ( M ) ; ℛ ( I ) ) \\ I\end{matrix} \qquad ( 7 )$$

where [symbol] represents the loss function (e.g. mean squared error) used to indicate the reconstruction accuracy of the rendering operator.

The updated formulation of all pixel values in the emission image I is achieved by applying gradient descent-based optimization techniques:

$${I}^{k + 1} = {I}^{k} - η \frac{\partial ℒ}{\partial {I}^{k}} , \qquad ( 8 )$$

η is the learning rate of the gradient in each step. The term

$$\frac{\partial ℒ}{\partial {I}^{k}}$$

is the gradient propagated from the loss function on k th iteration. The new emission image [symbol] ^{k+1} will serve as the input for the subsequent iteration of the image reconstruction process.

Application and Preliminary Results: To evaluate the reconstruction performance, example embodiments first simulated a hot-spot phantom with spot diameters of 0.60, 0.70, 0.80, 0.90, 1.00, and 1.25 mm using the GATE Monte Carlo simulation toolbox. Acolinearity blurring was modeled, and 9 million coincidence events were recorded. Images were reconstructed using IR with a pixel size of 0.25×0.25×0.25 mm³, Sobel sampler, and LBFGS optimizer with 250 iterations. An iteration number of 100 was selected for MLEM to match clinical procedures. PSF modeling was applied to both reconstruction methods.

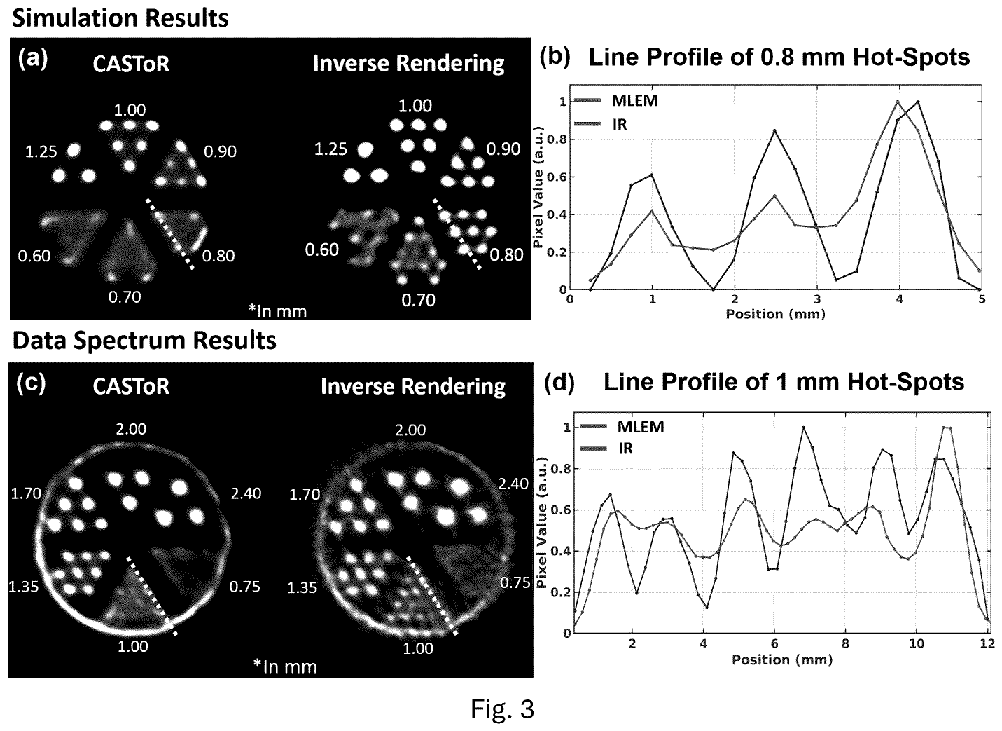

FIG. 3, at (a), displays the reconstructed hot-spot phantom featuring a minimum diameter of 0.6 mm for the hotspots. While the MLEM method demonstrates optimal separation with a hot-spot diameter of 0.8 mm, the IR model produces clear separation even with a hot-spot diameter as small as 0.7 mm in the reconstructed image. FIG. 3, at (b), is the line profiles of hot-spots with diameters of 0.8 mm. The peaks of pixel values along the lines are distinctly visible in the hot-spots reconstructed from the IR model, in contrast to those from MLEM.

Example embodiments also tested the IR reconstruction using experimental phantom data. A hot-spot phantom from Data Spectrum, Inc. was filled with 1.5 mCi of F18-FDG radiotracer, and 30 million coincidence events were recorded. The iteration numbers for MLEM and IR were 200 and 100, respectively.

FIG. 3, at (c), shows the hot-spots phantom fabricated by Data Spectrum, with a minimum hot-spot size of 0.75 mm. The MLEM method provides the best separation for hot-spots with a diameter of 1.35 mm, while the IR method achieves the best separation for hot-spots as small as 1 mm in the reconstructed image. FIG. 3, at (d), presents the line profiles of hot-spots with a diameter of 1 mm. The pixel value peaks along the lines are more distinctly visible in the hot-spots reconstructed with the IR model compared to those reconstructed with MLEM.

### Path-Space Framework for Back-To-Back Gamma Photons in PET

The path space formulation of light transport formulates a simulation task as an integral over a high-dimensional space of light paths. This mathematical framework is compatible with arbitrary path sampling strategies. Consider a set [symbol] containing paths with n successive interactions with scene surfaces S, of which the first and last interactions model emission and detection. Rendering algorithms then integrate over a union [symbol] of such spaces with different lengths:

$${𝒫}_{n} = \{ {x}_{1} … {x}_{n} \vert {x}_{i} ∈ S \} , 𝒫 = {⋃}_{n = 2}^{∞} {𝒫}_{i} \qquad ( 9 )$$

The intensity Iⱼ of a pixel j can be formulated as a weighted integral over this domain.

$$\begin{matrix}{I}_{j} = {\int }_{𝒫} {f}^{( j )} ( \overline{x} ) dP ( \overline{x} ) \\ = \int {\int }_{S} {f}^{( j )} ( {x}_{1} , {x}_{2} ) d A ( {x}_{1} ) dA ( {\overline{x}}_{2} ) + \\ \int \int {\int }_{S} {f}^{( j )} ( {x}_{1} , {x}_{2} , {x}_{3} ) dA ( {x}_{1} ) dA ( {x}_{2} ) dA ( {x}_{3} ) + …\end{matrix} \qquad \begin{matrix}\begin{matrix}( 10 ) \\ \end{matrix} \\ ( 11 )\end{matrix}$$

Here, dP(⋅) and dA(⋅) indicate integration over path space versus area elements.

The definition of the function ƒ^{j}(x) depends on the dimension of the input and consists of a product of terms, one for each vertex and edge of the underlying path. Below is an example for a path with 3 vertices:

$${f}^{( j )} ( {x}_{1} , … , {x}_{4} ) = {L}_{e} ( {x}_{1} , {x}_{2} ) G ( {x}_{1} , {x}_{2} ) {f}_{s} ( {x}_{1} , {x}_{2} , {x}_{3} ) G ( {x}_{2} , {x}_{3} ) {W}_{e}^{( j )} ( {x}_{2} , {x}_{3} ) \qquad ( 12 )$$

Here:
Lₑ: characterizes the emission profile of the light source
Wₑ^{(j)}: characterizes the sensitivity profile of pixel j of the sensor
G is the geometric term, which models the influence of transport through space (potentially an absorbing medium).
ƒₛ is the bidirectional scattering distribution function (BSDF), which quantifies how much of the light arriving from one direction scatters towards another.

What is shown above is the surface version of this framework, but this has been generalized to paths including volumetric interactions as well.

Path space for PET: Various embodiments implement an extended path space

$${\tilde{𝒫}}_{n}^{k} = \{ {x}_{1} … {x}_{k} … {x}_{n} \vert {x}_{1} , {x}_{n} ∈ C , {x}_{2} … {x}_{n - 1} ∈ V , \qquad ( 13 )$$

$${x}_{k} = {ax}_{k - 1} + ( 1 - a ) {x}_{k + 1} , a ∈ [ 0 , 1 ] \} \qquad ( 14 )$$

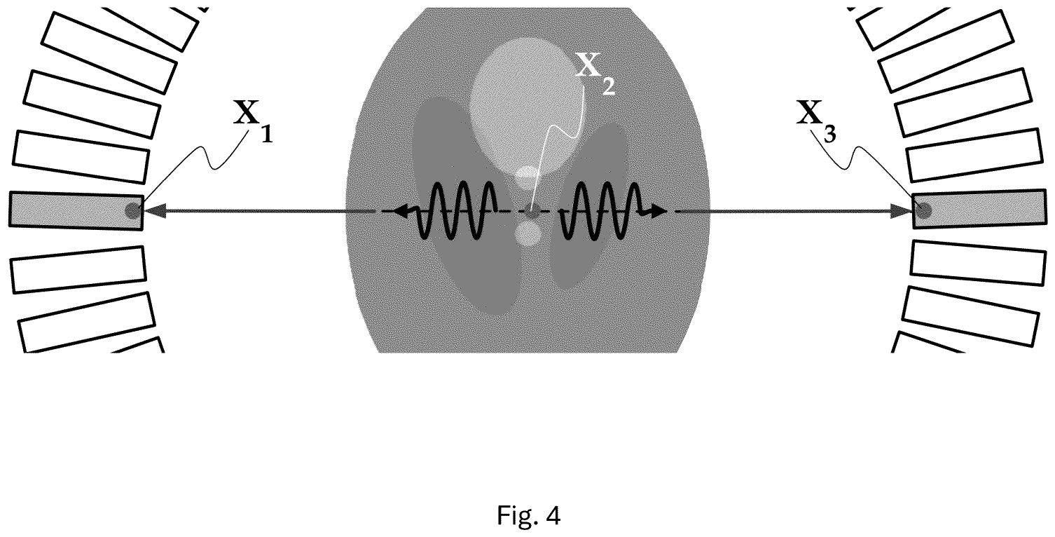

A main difference is that the path now terminates in crystals C on both sides (i.e., x₁ and xₙ), interacts with a volume V elsewhere, and has a special vertex xₖ that models the positron annihilation. The second line of the equation states that this vertex xₖ lies on a line segment connecting vertices xₖ₋₁ and xₖ₊₁, which models the back-to-back gamma photon emission (see, e.g., FIG. 4).

Integration over such a generalized path space must then consider the constrained nature of the positron emission event. In various embodiments, the following expressions compute the sinogram intensity of a line of response involving crystals Cᵢ and Cⱼ considering paths with three vertices:

$${\int }_{{𝒫}_{3}^{2}} {f}^{( ij )} ( \overline{x} ) dP ( \overline{x} ) = {\int }_{C} {\int }_{C} {\int }_{{x}_{1}}^{{x}^{3}} {f}^{( ij )} ( {x}_{1} , {x}_{2} , {x}_{3} ) d L ( {x}_{2} ) dV ( {x}_{1} ) dV ( {x}_{3} ) . \qquad ( 15 )$$

Note how the integration involving the middle vertex has collapsed to a lower-dimensional 1D line integral from vertex x₁ to x₃.

For such short paths without scattering (see, e.g., FIG. 4), the contribution function ƒ^{(ij)} is given by

$${f}^{( ij )} ( {x}_{1} , {x}_{2} , {x}_{3} ) = {W}_{e}^{( i )} ( {x}_{1} , {x}_{2} ) Φ ( {x}_{2} ) {W}_{e}^{( j )} ( {x}_{2} , {x}_{3} ) , \qquad ( 16 )$$

where the added function ϕ(x) models the density of the radio-tracer at position x.

In various embodiments, with respect to PET, a simple model for the sensitivity function Wₑⁱ(x₁, x₂) is the indicator function based on position, ignoring the the direction x₂→x₁ of the incident X-ray photon:

$${W}_{e}^{i} ( {x}_{1} , {x}_{2} ) = \{ \begin{matrix}1 & {x}_{1} ∈ {C}_{i} \\ 0 & {x}_{i} ∉ {C}_{i}\end{matrix} \qquad ( 17 )$$

Combining Equations 15, 16, and 17 yields

$${I}_{ij} = {\int }_{{𝒫}_{3}^{2}} {f}^{( ij )} ( \overline{x} ) dP ( \overline{x} ) = {\int }_{C} {\int }_{C} {\int }_{{x}_{1}}^{{x}^{3}} Φ ( {x}_{2} ) d L ( {x}_{2} ) dV ( {x}_{1} ) dV ( {x}_{3} ) . \qquad ( 18 )$$

In various embodiments, a Monte Carlo integrator estimates this expression to obtain the LOR sinogram. This is a 7-dimensional integral (3 dimensions for each crystal for the start/end positions, and another dimensions to consider different positron emission events along the line of response).

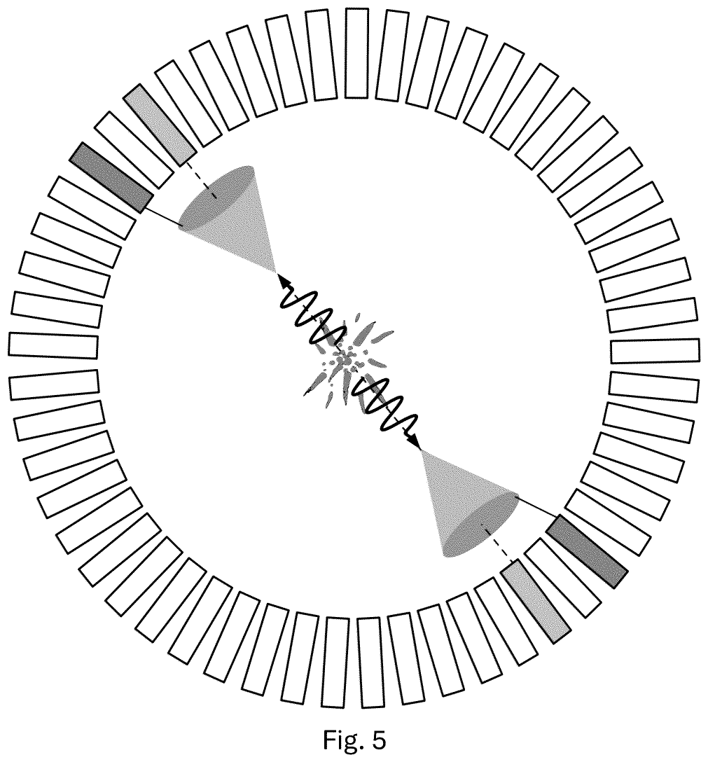

Using this path-space framework, there is flexibility to calculate more complex scenarios, for examples cases with Compton scattering (see, e.g., FIG. 5).

To account for them, various embodiments of the simulation consider paths of all different configurations:

$$\tilde{𝒫} = {⋃}_{n = 3}^{∞} {⋃}_{k = 2}^{n - 1} {\tilde{𝒫}}_{n}^{k} , \qquad ( 19 )$$

Here is an example of the path contribution function for a path with 5 vertices (detection, scattering, annihilation, scattering, detection) considering the sensitivity along a line of response involving crystals Cᵢ and Cⱼ:

$${f}^{( ij )} ( {x}_{1} , … , {x}_{3} , … , {x}_{5} ) = {W}_{e}^{( i )} ( {x}_{1} , {x}_{2} ) G ( {x}_{1} , {x}_{2} ) {f}_{s} ( {x}_{1} , {x}_{2} , {x}_{3} ) Φ ( {x}_{3} ) {f}_{s} ( {x}_{3} , {x}_{4} , {x}_{5} ) G ( {x}_{4} , {x}_{5} ) {W}_{e}^{( j )} ( {x}_{4} , {x}_{5} ) , \qquad ( 20 )$$

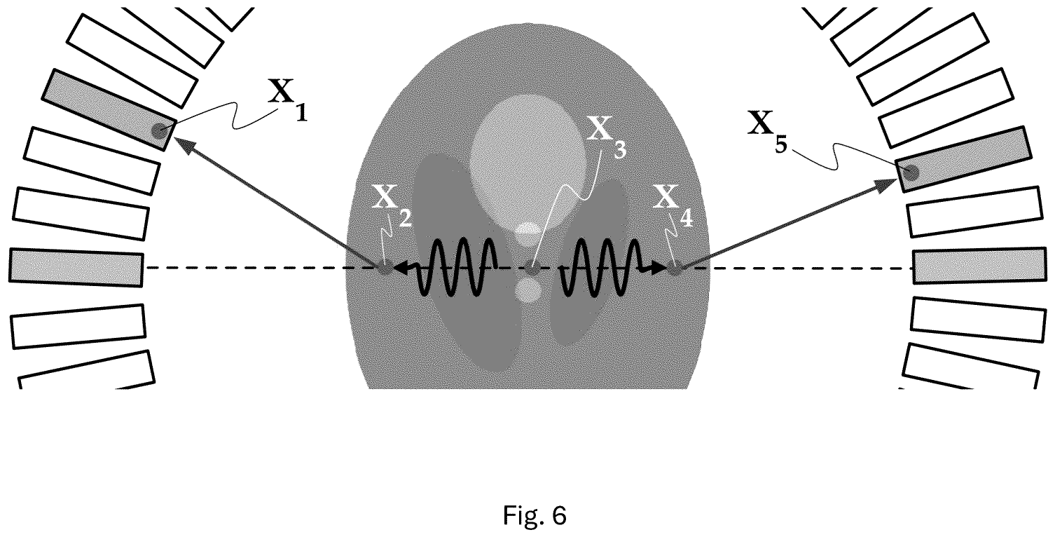

FIG. 6 provides a schematic of path tracing for back-to-back gamma starting from X₁, followed by a Compton scattering to X₂, meeting at the point of positron annihilation at X₃, then another Compton scattering at X₄, and finally, the termination of the second gamma photon at X₅ where X₁ and X₅ are at the crystal.

To solve everything for a specific case of FIG. 6, going through the math proves that this is actually what GATE is computing. So, various embodiments use the path-integral framework.

To reconstruct the emission image, various embodiments begin with an initial estimate of the image. This serves as the starting point for forward rendering, where the forward projection process is simulation. In this process, various embodiments may utilize Sobol sampling to achieve accurate Monte Carlo estimation, employ a digital differential analyzer (DDA) projector to calculate integral values, and implement normalization and attenuation correction. This procedure produces a rendered sinogram.

To evaluate the accuracy of the estimate, various embodiments define an objective function that quantifies the discrepancy between the rendered and measured sinograms. Minimizing this discrepancy involves leveraging automatic differentiation and backpropagation to compute the gradient of the objective function with respect to each voxel in the image. A gradient-based optimization algorithm, such as gradient descent or Adam, can then use this gradient information to iteratively refine the voxel values, thereby improving the reconstruction quality.

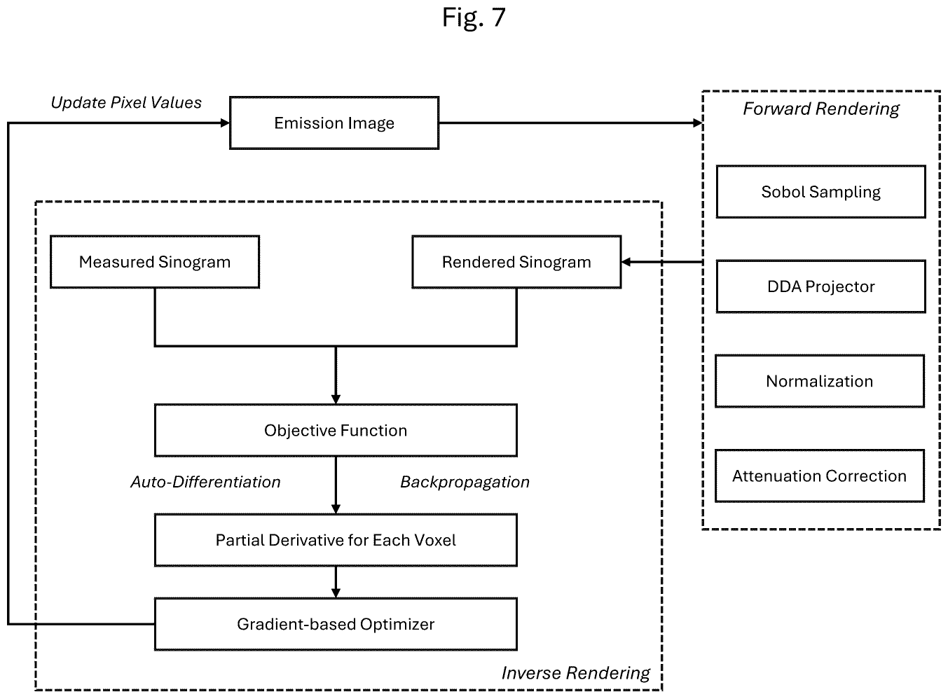

Unlike traditional image reconstruction methods, various embodiments of the inverse rendering platform integrate auto-differentiation to compute the necessary partial derivatives for each voxel automatically (see, e.g., FIG. 7). This approach not only streamlines the reconstruction process by eliminating labor-intensive manual derivative calculations but also enhances both the accuracy and efficiency of the reconstruction.

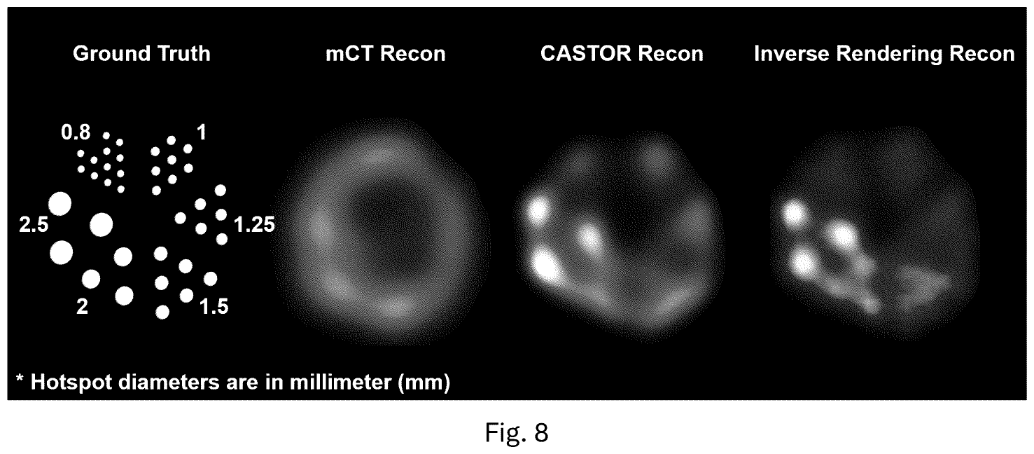

With respect to FIG. 8, the results present a comparison of ultra-micro phantom reconstruction across three platforms. The leftmost image displays the ground truth, with hotspot diameters ranging from 2.5 mm down to 0.8 mm. The experiment was conducted using a source activity of 1.5 mCi, yielding a total of approximately 100 million counts. All three reconstruction methods—the mCT vendor's reconstruction, CASToR's reconstruction, and inverse rendering reconstruction—utilize a consistent voxel size of 2×2×2 mm³. Both the mCT vendor and CASToR reconstructions employed 4 iterations with 21 subsets of the OSEM algorithm, while the inverse rendering method utilized 84 iterations of the MLEM algorithm.

Inverse Rendering for High Resolution PET Image Reconstruction with PSF and TOF Modeling

In various embodiments, incorporating point spread function (PSF) and time-of-flight (TOF) modeling into PET image reconstruction accounts for the physical nature of photon transport from object space to measurement space. Example embodiments of this disclosure integrate PSF modeling within the inverse rendering-based reconstruction platform and introduce a modified digital differential analyzer (DDA) to accurately model TOF effects. This approach evaluated using Data Spectrum hotspot phantom and clinical tau PET data. In various embodiments of the inverse rendering platform, forward projection may be implemented through Monte Carlo estimation, where multiple points are randomly sampled within the crystals to define sub-lines of response (sub-LORs). For PSF modeling, Gaussian noise with zero mean may be added to the sample positions to simulate spatial uncertainty in photon detection. Moreover, a modified DDA algorithm that weights voxel intensities according to the Gaussian kernel centered at TOF estimated position may be used to incorporate TOF information. The phantom and clinical images were reconstructed using both CASToR and the inverse rendering platform for comparison. The line profile of 1 mm diameter hotspots indicates the inverse rendering platform achieved a 33% higher average peak-to-valley ratio (PVR) compared to CASToR. Clinical results further demonstrated reduced partial volume effects and higher contrast in the regions of interest. In various embodiments, the disclosed inverse rendering platform enables more accurate PET imaging for improved disease assessment.

The use of statistical modeling methods with more comprehensive system matrix designs significantly improves the spatial resolution and signal-to-noise ratio (SNR) of PET images. Instead of relying on the simple line integral model for the forward projection, more integrate additional physical factors, such as spatially variant detector response and the probabilistic distribution of annihilation locations informed by time-of-flight (TOF) differences.

As discussed above, in various embodiments of the inverse rendering platform, the unknown emission image is represented as learnable scene parameters, and the physically based forward rendering process is implemented to simulate the projection data. Also, the use of gradient-based optimization iteratively updates the image estimate.

In various embodiments, this framework is extended by involving point spread function (PSF) modeling to further enhance spatial resolution and using a modified digital differential analyzer (DDA) to improve the implementation of TOF. The clinical results demonstrate this platform can, for example, enhance spatial resolution in tau PET imaging, which supports its capabilities to improve Braak staging in Alzheimer's disease.

In PET imaging, the projection data y∈ [symbol] ^{I} are typically modeled as independent Poisson distributed measurements. The expected value of the projection data E[y] is related to the unknown emission image x∈ [symbol] ^{J} through an affine approximation

$$E ⌈ y ] = Px + r + s \qquad ( 21 )$$

where the system matrix P∈ [symbol] ^{I×J} maps the unknow image to the measured projections, r∈ [symbol] ^{I} and s∈ [symbol] ^{I} demonstrate the expected contribution from random and scattered events, respectively. The element of system matrix Pᵢⱼ represents the average probability that a gamma photon emitted from voxel j is detected along the i-th line of response (LOR).

In embodiments of the disclosed inverse rendering platform, the forward projection unknown emission image is implemented using the Monte Carlo estimation within the “Dr. Jit” engine. Different from the deterministic forward projection operator, the disclosed approach improves the modeling accuracy by compensating for the loss information due to the finite basis function representation. The multiple randomized sub-lines of response (sub-LORs) between each crystal pairs are generated through Monte Carlo sampling, resulting in a more accurate estimation of the expected projection data.

The PSF is a powerful tool for characterizing the fundamental physics of positron emission, annihilation and the spatial response of the PET detection system. Integrating PSF modeling into the reconstruction process allows for the accurate compensation of image blurring and resolution loss. Embodiments of the disclosed inverse rendering platform incorporate PSF into the forward Monte Carlo rendering process. Example embodiments first randomly sample points p within the crystals, where each point is uniformly distributed from the physical dimension (width, height and length) of the crystal volume. Example embodiments introduce the perturbation to the sampled points by adding a Gaussian noise δ˜N(0, σ² [symbol] ) along each dimension. The perturbed sample location is given by

$${p}^{′} = p - δ , \qquad ( 22 )$$

where the perturbation vector δ∈ [symbol] ³ effectively incorporates PSF directly into the forward rendering model by modeling the spatial uncertainty in photon detection.

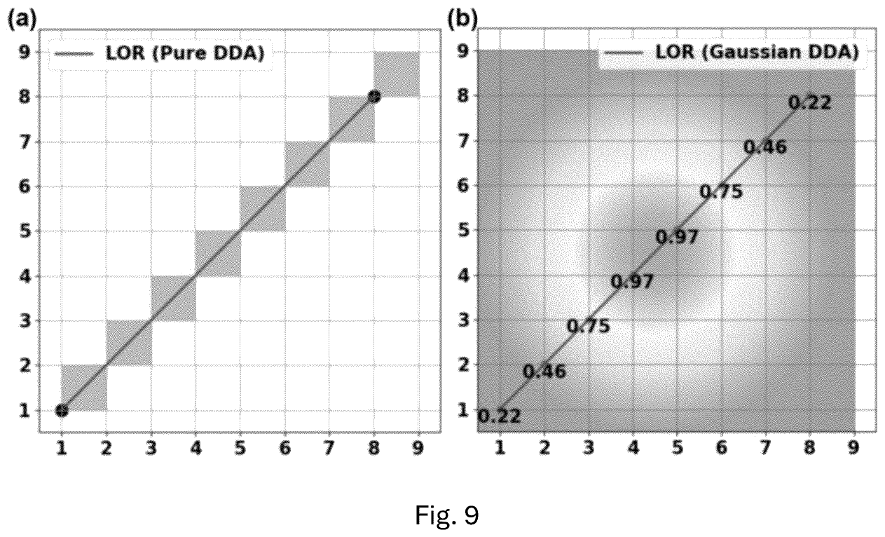

To incorporate TOF information into the forward rendering process, example embodiments model the annihilation position along the LOR through a Gaussian distribution centered at the TOF estimated position, instead of assuming the uniform distribution along the entire LOR. The measured sinogram is extended with an additional dimension representing the discretized TOF kernels. In the forward rendering, the contribution of a voxel intensity to the expected projection is weighted by the corresponding TOF Gaussian kernel, which enables the spatially localized modeling of the emission probability. Example embodiments introduce the modified DDA algorithm incorporating TOF uncertainty to implement this process. The modified DDA is more accurate to achieve Gaussian kernel-based weight than the finite Monte Carlo sampling which can suffer from the high variance when the number of sampling points is insufficient (see, e.g., FIG. 9).

With example embodiments incorporating TOF modeling, the overall objective function is defined as a summation over all TOF kernels

$${L}_{total} = {\sum }_{n = 1}^{N} {L}_{{TOF}_{n}} = {\sum }_{n = 1}^{N} ℒ ( {y}_{n} , {P}_{n} \hat{x} ) \qquad ( 23 )$$

where yₙ represents the measured sinogram data in the n-th TOF kernel, Pₙ is the corresponding system matrix incorporating TOF kernel weighting, and \hat{x} is the estimated emission image. The function £ measures the difference between the measured and rendered projections, which typically adopts a negative Poisson log-likelihood form (Eq. 24). The automatic differentiation mechanism would be implemented in example embodiments of the platform incorporating the gradient-based optimization to update the emission image voxel value during each iteration.

$${L}_{total} = {\sum }_{n = 1}^{N} {\sum }_{j} [ {( {P}_{n} \hat{x} )}_{j} - {y}_{n , j} {log ( {P}_{n} \hat{x} )}_{j} ] \qquad ( 24 )$$

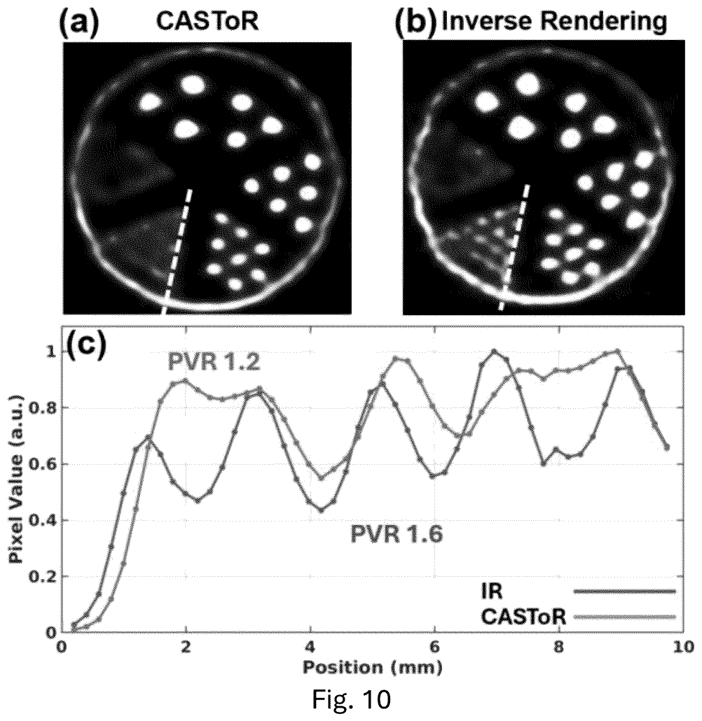

FIG. 10, at (a) and (b), show the reconstructed images of hotspot phantom using CASToR and inverse rendering platform, respectively. FIG. 10, at (c), shows the line profile analysis across 1 mm diameter hotspots. The curves demonstrate that inverse rendering platform achieves better resolution, generating a higher peak-to-valley ratio (PVR) of 1.6 compared to 1.2 with CASToR.

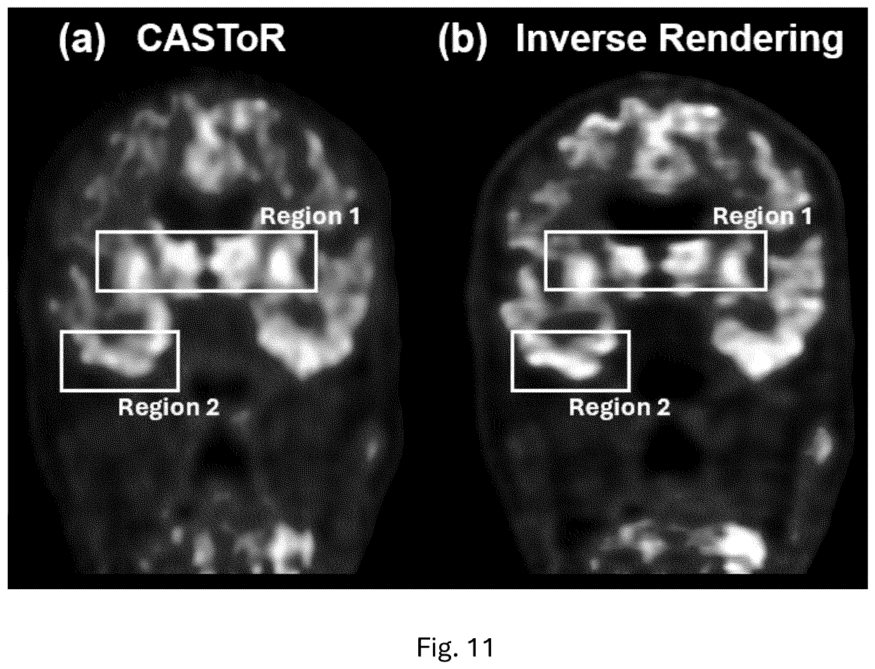

FIG. 11 shows improved anatomical delineation due to reduced partial volume effects. “Region 1” highlights better separation between the parahippocampal gyrus and entorhinal cortex, which are the key regions in Braak stage I. Region 2 indicates the improved contrast between the inferior temporal cortex and the basal skull, minimizing spill-in from adjacent bone. The enhanced resolution in the medial temporal lobe illustrates the inverse rendering platform's potential for accurate tau localization and Braak staging.

Various embodiments incorporate both PSF and TOF modeling into the inverse rendering-based platform for PET image reconstruction. The improved spatial resolution and reduced partial volume effects observed in the clinical results demonstrate the platform's ability to enhance PET imaging.

### Example Advantages of Inverse Rendering: Efficient Monte Carlo Simulation

Various embodiments of the platform support Monte Carlo simulation of millions of random samples with consistent computational performance. This enables a more realistic forward projection process by accurately modeling statistical processes. In practice, gamma photons traveling from the emission source to the detector can undergo three possible interactions: scattering, absorption (attenuation), or transmission, all governed by the statistical properties of the medium's attenuation coefficient (μ). Monte Carlo methods naturally capture this probabilistic behavior by simulating each possible outcome along the photon path. This approach also enables modeling attenuation effects within the forward model itself, offering the potential for CT-less attenuation correction during PET image reconstruction.

The Compton scatter process is inherently statistical, and accurate simulation of annihilation photon trajectories with large numbers of samples is particularly helpful for capturing this effect.

Additionally, modeling the volume of scintillation crystals recognizes that the two ends of a line of response (LOR) may not always align with the centers of the crystals. Instead, they can follow specific distributions (e.g., uniform or Gaussian). Monte Carlo simulation of multiple sub-LORs in each crystal pair allows for averaging line integrals that more closely match measured data.

### Example Advantages of Inverse Rendering: Automatic Differentiation Mechanism

In various embodiments, automatic differentiation (AD) is seamlessly integrated into the inverse rendering framework. When considering complex physics processes like Compton scatter and attenuation in the forward model, the equations become complicated, making manual gradient derivation impractical. AD enables efficient and accurate computation of gradients with respect to each pixel value, supporting iterative image optimization.

Moreover, for higher-level optimization tasks—such as scanner geometry calibration—AD allows the calculation of gradients of unknown parameters that may not have explicit analytical forms, facilitating comprehensive system calibration.

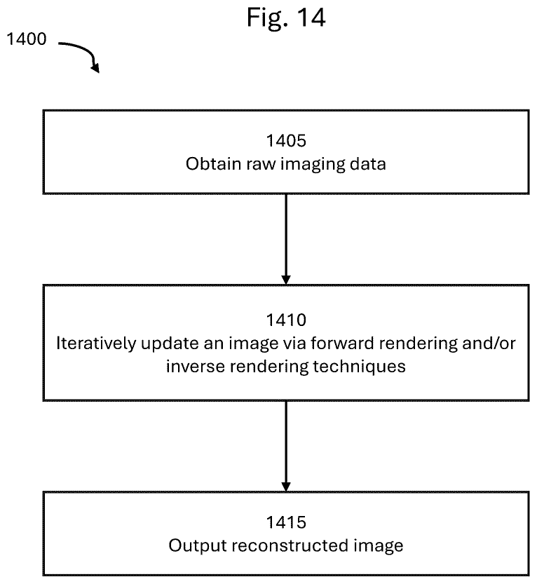

Referring to FIG. 14, an example flowchart 1400 is presented, according to various embodiments of the disclosure. At block 1405, a system comprising one or more processors. The system may be or may comprise, for example, a PET system, and/or one or more computing systems and/or computing devices connected, via wires or wirelessly, through any suitable communication protocol, to the PET system. The one or more computing systems and/or devices may alternatively or additionally be connected to a networked data storage system (e.g., a cloud computing system) and/or an information system (e.g., a health information system) capable of receiving data, directly or indirectly, from or via the PET system.

At block 1405, raw imaging data may be obtained. This may be directly from a PET system running scans, or indirectly from another computing system or device. The raw imaging data is obtained following administration of a radiotracer labeled with a positron-emitting isotope to a human or non-human subject or patient. The raw data may be, or may undergo certain processing steps to become, measured sinogram data.

At block 1410, one or more forward rendering models and inverse rendering models may be applied to the data. The forward rendering and inverse rendering techniques may be applied iteratively until a stopping condition is satisfied. In various embodiments, block 1410 comprises iteratively updating pixel values of an emission image until the stopping criterion. Forward rendering may be performed to generate a rendered sinogram. Performing forward rendering may comprise sampling a number of positions corresponding to each crystal detector in a plurality of crystal detectors, the positions defining lines of response (LORs) between crystal pairs. Inverse rendering may be performed based on the measured sinogram data and the rendered sinogram. Performing inverse rendering may comprise applying auto-differentiation for gradient-based optimization. The stopping condition may be minimization of a loss function or a certain number of iterations based on prior experiences.

At block 1415, a reconstructed image is output. Outputting the image may comprise any combination of one or more of: displaying the image on one or more display devices; storing the image for later retrieval, locally and/or remotely (e.g., via a network connection such as a wide area network or the internet); transmitting the image to one or more computing systems or computing devices for display or further processing; and/or transmitting the image to one or more computing systems or computing devices for storage in non-volatile computer memory and/or archival. A reconstructed PET image may be based on the updated emission image following the stopping criterion being satisfied.

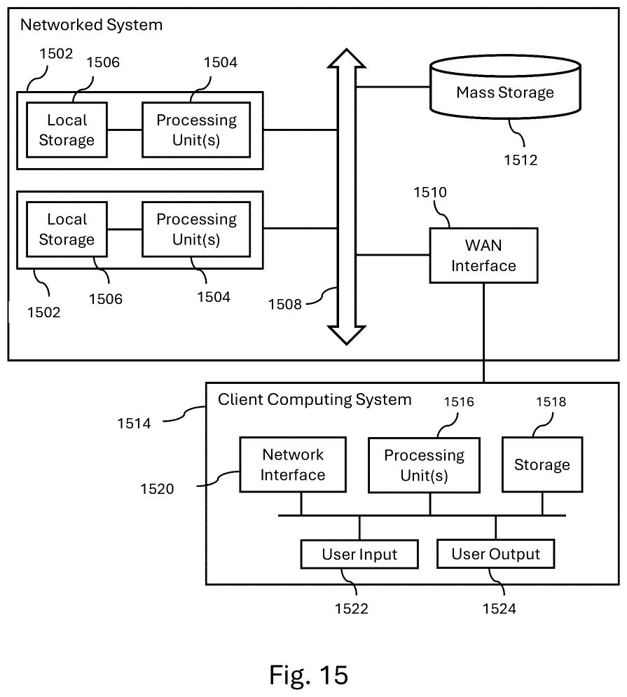

Various operations described herein can be implemented on computer systems having various configurations. FIG. 15 shows a simplified block diagram of a representative networked system 1500 (used interchangeably with server system) and client computer system 1514 (e.g., a PET system and/or one or more user computing devices such as desktop computers, laptops, smartphones or other mobile devices, workstations, etc.) usable to implement various embodiments of the present disclosure. In various embodiments, server system 1500 or similar systems can implement services or servers described herein or portions thereof. Client computer system 1514 or similar systems can implement clients described herein.

Server system 1500 can have a modular design that incorporates a number of modules 1502 (e.g., blades in a blade server embodiment); while two modules 1502 are shown, any number can be provided. Each module 1502 can include processing unit(s) 1504 and local storage 1506.

Processing unit(s) 1504 can include a single processor, which can have one or more cores, or multiple processors. In some embodiments, processing unit(s) 1504 can include a general-purpose primary processor as well as one or more special-purpose co-processors such as graphics processors, digital signal processors, or the like. In some embodiments, some or all processing units 1504 can be implemented using customized circuits, such as application specific integrated circuits (ASICs) or field programmable gate arrays (FPGAs). In some embodiments, such integrated circuits execute instructions that are stored on the circuit itself. In other embodiments, processing unit(s) 1504 can execute instructions stored in local storage 1506. Any type of processors in any combination can be included in processing unit(s) 1504.

Local storage 1506 can include volatile storage media (e.g., conventional DRAM, SRAM, SDRAM, or the like) and/or non-volatile storage media (e.g., magnetic or optical disk, flash memory, or the like). Storage media incorporated in local storage 1506 can be fixed, removable or upgradeable as desired. Local storage 1506 can be physically or logically divided into various subunits such as a system memory, a read-only memory (ROM), and a permanent storage device. The system memory can be a read-and-write memory device or a volatile read-and-write memory, such as dynamic random-access memory. The system memory can store some or all of the instructions and data that processing unit(s) 1504 need at runtime. The ROM can store static data and instructions that are needed by processing unit(s) 1504. The permanent storage device can be a non-volatile read-and-write memory device that can store instructions and data even when module 1502 is powered down. The term “storage medium” as used herein includes any medium in which data can be stored indefinitely (subject to overwriting, electrical disturbance, power loss, or the like) and does not include carrier waves and transitory electronic signals propagating wirelessly or over wired connections.

In some embodiments, local storage 1506 can store one or more software programs to be executed by processing unit(s) 1504, such as an operating system and/or programs implementing various server functions or any system or device described herein.

“Software” refers generally to sequences of instructions that, when executed by processing unit(s) 1504 cause server system 1500 (or portions thereof) to perform various operations, thus defining one or more specific machine embodiments that execute and perform the operations of the software programs. The instructions can be stored as firmware residing in read-only memory and/or program code stored in non-volatile storage media that can be read into volatile working memory for execution by processing unit(s) 1504. Software can be implemented as a single program or a collection of separate programs or program modules that interact as desired. From local storage 1506 (or non-local storage described below), processing unit(s) 1504 can retrieve program instructions to execute and data to process in order to execute various operations described above.

In some server systems 1500, multiple modules 1502 can be interconnected via a bus or other interconnect 1508, forming a local area network that supports communication between modules 1502 and other components of server system 1500. Interconnect 1508 can be implemented using various technologies including server racks, hubs, routers, etc.

A wide area network (WAN) interface 1510 can provide data communication capability between the local area network (interconnect 1508) and a larger network, such as the Internet. Conventional or other activities technologies can be used, including wired (e.g., Ethernet, IEEE 802.3 standards) and/or wireless technologies (e.g., Wi-Fi, IEEE 802.11 standards).

In some embodiments, local storage 1506 is intended to provide working memory for processing unit(s) 1504, providing fast access to programs and/or data to be processed while reducing traffic on interconnect 1508. Storage for larger quantities of data can be provided on the local area network by one or more mass storage subsystems 1512 that can be connected to interconnect 1508. Mass storage subsystem 1512 can be based on magnetic, optical, semiconductor, or other data storage media. Direct attached storage, storage area networks, network-attached storage, and the like can be used. Any data stores or other collections of data described herein as being produced, consumed, or maintained by a service or server can be stored in mass storage subsystem 1512. In some embodiments, additional data storage resources may be accessible via WAN interface 1510 (potentially with increased latency).

Server system 1500 can operate in response to requests received via WAN interface 1510. For example, one of modules 1502 can implement a supervisory function and assign discrete tasks to other modules 1502 in response to received requests. Conventional work allocation techniques can be used. As requests are processed, results can be returned to the requester via WAN interface 1510. Such operation can generally be automated. Further, in some embodiments, WAN interface 1510 can connect multiple server systems 1500 to each other, providing scalable systems capable of managing high volumes of activity. Conventional or other techniques for managing server systems and server farms (collections of server systems that cooperate) can be used, including dynamic resource allocation and reallocation.

Server system 1500 can interact with various user-owned or user-operated devices via a wide-area network such as the Internet. An example of a user-operated device is shown in FIG. 15 as client computing system 1514. Client computing system 1514 can be implemented, for example, as a consumer device such as a smartphone, other mobile phone, tablet computer, wearable computing device (e.g., smart watch, eyeglasses), desktop computer, laptop computer, and so on.

Client computing system 1514 can communicate via WAN interface 1510. Client computing system 1514 can include conventional computer components such as processing unit(s) 1516, storage device 1518, network interface 1520, user input device 1522, and user output device 1524. Client computing system 1514 can be a computing device implemented in a variety of form factors, such as a desktop computer, laptop computer, tablet computer, smartphone, other mobile computing device, wearable computing device, or the like.

Processor 1516 and storage device 1518 can be similar to processing unit(s) 1504 and local storage 1506 described above. Suitable devices can be selected based on the demands to be placed on client computing system 1514; for example, client computing system 1514 can be implemented as a “thin” client with limited processing capability or as a high-powered computing device. Client computing system 1514 can be provisioned with program code executable by processing unit(s) 1516 to enable various interactions with server system 1500 of a message management service such as accessing messages, performing actions on messages, and other interactions described above. Some client computing systems 1514 can also interact with a messaging service independently of the message management service.

Network interface 1520 can provide a connection to a wide area network (e.g., the Internet) to which WAN interface 1510 of server system 1500 is also connected. In various embodiments, network interface 1520 can include a wired interface (e.g., Ethernet) and/or a wireless interface implementing various RF data communication standards such as Wi-Fi, Bluetooth, or cellular data network standards (e.g., 3G, 4G, 5G, LTE, etc.).

User input device 1522 can include any device (or devices) via which a user can provide signals to client computing system 1514; client computing system 1514 can interpret the signals as indicative of particular user requests or information. In various embodiments, user input device 1522 can include any or all of a keyboard, touch pad, touch screen, mouse or other pointing device, scroll wheel, click wheel, dial, button, switch, keypad, microphone, and so on.

User output device 1524 can include any device via which client computing system 1514 can provide information to a user. For example, user output device 1524 can include a display to display images generated by or delivered to client computing system 1514. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). Some embodiments can include a device such as a touchscreen that function as both input and output device. In some embodiments, other user output devices 1524 can be provided in addition to or instead of a display. Examples include indicator lights, speakers, tactile “display” devices, printers, and so on.

Some embodiments include electronic components, such as microprocessors, storage and memory that store computer program instructions in a computer readable storage medium. Many of the features described in this specification can be implemented as processes that are specified as a set of program instructions encoded on a computer readable storage medium. When these program instructions are executed by one or more processing units, they cause the processing unit(s) to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processing unit(s) 1504 and 1516 can provide various functionality for server system 1500 and client computing system 1514, including any of the functionality described herein as being performed by a server or client, or other functionality associated with message management services.

It will be appreciated that server system 1500 and client computing system 1514 are illustrative and that variations and modifications are possible. Computer systems used in connection with embodiments of the present disclosure can have other capabilities not specifically described here. Further, while server system 1500 and client computing system 1514 are described with reference to particular blocks, it is to be understood that these blocks are defined for convenience of description and are not intended to imply a particular physical arrangement of component parts. For instance, different blocks can be but need not be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present disclosure can be realized in a variety of apparatus including electronic devices implemented using any combination of circuitry and software.

Various non-limiting example embodiments include the following combinable embodiments/aspects/features:

### “A” EMBODIMENTS

Embodiment A1: A method for reconstructing positron emission tomography (PET) images using a computing system comprising one or more processors, the method comprising: receiving measured sinogram data from one or more scans by a PET scanner, the measured sinogram data representing measured projections from the PET scanner; iteratively updating pixel values of an emission image until a stopping criterion, comprising: performing forward rendering to generate a rendered sinogram, wherein performing forward rendering comprises sampling a number of positions corresponding to each crystal detector in a plurality of crystal detectors, the positions defining lines of response (LORs) between crystal pairs; and performing inverse rendering based on the measured sinogram data and the rendered sinogram, wherein performing inverse rendering comprises applying auto-differentiation for gradient-based optimization; and outputting a reconstructed PET image based on the updated emission image following the stopping criterion being met.

Embodiment A2: Any “A” Embodiment, wherein performing forward rendering comprises physics-based modeling of physical processes affecting photon transport, wherein the physical processes comprise a combination of Compton scatter, attenuation, and/or transmission.

Embodiment A3: Any “A” Embodiment, comprising performing a simulation to model physical processes affecting photon transport, wherein the simulation accounts for statistical interactions of photons with a medium along each LOR.

Embodiment A4: Any “A” Embodiment, wherein the forward rendering comprises randomly sampling multiple points within each crystal detector to define sub-lines of response (sub-LORs).

Embodiment A5: Any “A” Embodiment, wherein performing inverse rendering comprises point spread function (PSF) modeling.

Embodiment A6: Any “A” Embodiment, wherein inverse rendering comprises adding Gaussian noise to sampled positions to simulate spatial uncertainty in photon detection.

Embodiment A7: Any “A” Embodiment, wherein inverse rendering comprises applying a modified digital differential analyzer (DDA) algorithm that weights voxel intensities according to a Gaussian kernel centered at time-of-flight (TOF).

Embodiment A8: Any “A” Embodiment, wherein performing inverse rendering comprises minimizing a loss function that quantifies a difference between the rendered sinogram and the measured sinogram data.

Embodiment A9: Any “A” Embodiment, wherein applying auto-differentiation enables simultaneous optimization of a plurality of parameters.

Embodiment A10: Any “A” Embodiment, comprising hyper-optimization of voxel intensities and attenuation coefficients.

Embodiment A11: Any “A” Embodiment, wherein the stopping criterion corresponds to minimization of an objective function.

Embodiment A12: Any “A” Embodiment, wherein the stopping criterion corresponds to the rendered sinogram closely matching measured data.

Embodiment A13: Any “A” Embodiment, wherein generating the rendered sinogram comprises integrating contributions from all sub-LORs across all TOF bins.

Embodiment A14: Any “A” Embodiment, wherein each LOR is divided into multiple TOF bins, centered symmetrically around a midpoint of the LOR, and for each bin, performing forward rendering comprises sampling points and evaluating the emission image at sampled points.

### “B” EMBODIMENTS

Embodiment B1: A computing system comprising one or more processors and being configured to reconstruct positron emission tomography (PET) images by performing the method of any “A” Embodiment.

Embodiment B2: A computing system comprising one or more processors and being configured to reconstruct positron emission tomography (PET) images by: receiving measured sinogram data from one or more scans by a PET scanner, the measured sinogram data representing measured projections from the PET scanner; iteratively updating pixel values of an emission image until a stopping criterion, comprising: performing forward rendering to generate a rendered sinogram, wherein performing forward rendering comprises sampling a number of positions corresponding to each crystal detector in a plurality of crystal detectors, the positions defining lines of response (LORs) between crystal pairs; and performing inverse rendering based on the measured sinogram and the rendered sinogram, wherein performing inverse rendering comprises applying auto-differentiation for gradient-based optimization; and outputting a reconstructed PET image based on the updated emission image following the stopping criterion being met.

Embodiment B3: Any “B” Embodiment, wherein performing forward rendering comprises physics-based modeling of physical processes affecting photon transport, wherein the physical processes comprise a combination of Compton scatter, attenuation, and/or transmission.

Embodiment B4: Any “B” Embodiment, wherein the forward rendering comprises randomly sampling multiple points within each crystal detector to define sub-lines of response (sub-LORs).

Embodiment B5: Any “B” Embodiment, wherein the forward rendering comprises randomly sampling multiple points within each crystal detector to define sub-lines of response (sub-LORs).

Embodiment B6: Any “B” Embodiment, wherein inverse rendering comprises adding Gaussian noise to sampled positions to simulate spatial uncertainty in photon detection.

Embodiment C1: A non-transitory computer-readable storage medium comprising instructions executable by one or more processors of a computing system to reconstruct positron emission tomography (PET) images by performing the method of any “A” Embodiment.

Embodiment C2: A non-transitory computer-readable storage medium comprising instructions executable by one or more processors of a computing system to reconstruct positron emission tomography (PET) images by: receiving measured sinogram data from one or more scans by a PET scanner, the measured sinogram data representing measured projections from the PET scanner; iteratively updating pixel values of an emission image until a stopping criterion, comprising: performing forward rendering to generate a rendered sinogram, wherein performing forward rendering comprises sampling a number of positions corresponding to each crystal detector in a plurality of crystal detectors, the positions defining lines of response (LORs) between crystal pairs; and performing inverse rendering based on the measured sinogram and the rendered sinogram, wherein performing inverse rendering comprises applying auto-differentiation for gradient-based optimization; and outputting a reconstructed PET image based on the updated emission image following the stopping criterion being met.

It should be noted that although method steps may be described in a specific order, it is understood that the order of these steps may differ from what is described. In a non-limiting example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. It is understood that all such variations are within the scope of the disclosure.

While this specification contains many specific embodiment details, these should not be construed as limitations on the scope of any inventions or of what may be claimed, but rather as descriptions of features specific to particular embodiments of the systems and methods described herein. Certain features that are described in this specification in the context of separate embodiments may also be embodied in combination in a single embodiment. Conversely, various features that are described in the context of a single embodiment may also be embodied in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Having now described some illustrative embodiments and embodiments, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements, and features discussed only in connection with one embodiment are not intended to be excluded from a similar role in other embodiments.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate embodiments consisting of the items listed thereafter exclusively. In one embodiment, the systems and methods described herein consist of one, each combination of more than one, or all of the described elements, acts, or components.

As utilized herein with respect to numerical ranges, the terms “approximately,” “about,” “substantially,” “essentially,” and similar terms generally mean+/−10% of the disclosed values. When the terms “approximately,” “about,” “substantially,” “essentially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements to single or plural configurations. References to any act or element being based on any information, act, or element may include embodiments where the act or element is based at least in part on any information, act, or element.

Any embodiment disclosed herein may be combined with any other embodiment, and references to “an embodiment,” “some embodiments,” “an alternate embodiment,” “various embodiments,” “one embodiment,” or the like are not necessarily mutually exclusive and are intended to indicate that a particular feature, structure, or characteristic described in connection with the embodiment may be included in at least one embodiment. Such terms as used herein are not necessarily all referring to the same embodiment. Any embodiment may be combined with any other embodiment, inclusively or exclusively, in any manner consistent with the aspects and embodiment disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes, and omissions may be made in the design, operating conditions and embodiment of the embodiments without departing from the scope of the present disclosure as expressed in the appended claims.

What is claimed is:

1. A method for reconstructing positron emission tomography (PET) images using a computing system comprising one or more processors, the method comprising:
receiving measured sinogram data from one or more scans by a PET scanner, the measured sinogram data representing measured projections from the PET scanner;
iteratively updating pixel values of an emission image until a stopping criterion, comprising:
performing forward rendering to generate a rendered sinogram, wherein performing forward rendering comprises sampling a number of positions corresponding to each crystal detector in a plurality of crystal detectors, the positions defining lines of response (LORs) between crystal pairs; and
performing inverse rendering based on the measured sinogram data and the rendered sinogram, wherein performing inverse rendering comprises applying auto-differentiation for gradient-based optimization; and
outputting a reconstructed PET image based on the updated emission image following the stopping criterion being met.

2. The method of claim 1, wherein performing forward rendering comprises physics-based modeling of physical processes affecting photon transport, wherein the physical processes comprise a combination of Compton scatter, attenuation, and/or transmission.

3. The method of claim 1, comprising performing a simulation to model physical processes affecting photon transport, wherein the simulation accounts for statistical interactions of photons with a medium along each LOR.

4. The method of claim 1, wherein the forward rendering comprises randomly sampling multiple points within each crystal detector to define sub-lines of response (sub-LORs).

5. The method of claim 1, wherein performing inverse rendering comprises point spread function (PSF) modeling.

6. The method of claim 1, wherein inverse rendering comprises adding Gaussian noise to sampled positions to simulate spatial uncertainty in photon detection.

7. The method of claim 1, wherein inverse rendering comprises applying a modified digital differential analyzer (DDA) algorithm that weights voxel intensities according to a Gaussian kernel centered at time-of-flight (TOF).

8. The method of claim 1, wherein performing inverse rendering comprises minimizing a loss function that quantifies a difference between the rendered sinogram and the measured sinogram data.

9. The method of claim 1, wherein applying auto-differentiation enables simultaneous optimization of a plurality of parameters.

10. The method of claim 1, comprising hyper-optimization of voxel intensities and attenuation coefficients.

11. The method of claim 1, wherein the stopping criterion corresponds to minimization of an objective function.

12. The method of claim 1, wherein the stopping criterion corresponds to the rendered sinogram closely matching measured data.

13. The method of claim 1, wherein generating the rendered sinogram comprises integrating contributions from all sub-LORs across all TOF bins.

14. The method of claim 1, wherein each LOR is divided into multiple TOF bins, centered symmetrically around a midpoint of the LOR, and for each bin, performing forward rendering comprises sampling points and evaluating the emission image at sampled points.

15. A computing system comprising one or more processors and being configured to reconstruct positron emission tomography (PET) images by:
receiving measured sinogram data from one or more scans by a PET scanner, the measured sinogram data representing measured projections from the PET scanner;
iteratively updating pixel values of an emission image until a stopping criterion, comprising:
performing forward rendering to generate a rendered sinogram, wherein performing forward rendering comprises sampling a number of positions corresponding to each crystal detector in a plurality of crystal detectors, the positions defining lines of response (LORs) between crystal pairs; and
performing inverse rendering based on the measured sinogram and the rendered sinogram, wherein performing inverse rendering comprises applying auto-differentiation for gradient-based optimization; and
outputting a reconstructed PET image based on the updated emission image following the stopping criterion being met.

16. The computing system of claim 15, wherein performing forward rendering comprises physics-based modeling of physical processes affecting photon transport, wherein the physical processes comprise a combination of Compton scatter, attenuation, and/or transmission.

17. The computing system of claim 15, wherein the forward rendering comprises randomly sampling multiple points within each crystal detector to define sub-lines of response (sub-LORs).

18. The computing system of claim 15, wherein the forward rendering comprises randomly sampling multiple points within each crystal detector to define sub-lines of response (sub-LORs).

19. The computing system of claim 15, wherein inverse rendering comprises adding Gaussian noise to sampled positions to simulate spatial uncertainty in photon detection.

20. A non-transitory computer-readable storage medium comprising instructions executable by one or more processors of a computing system to reconstruct positron emission tomography (PET) images by:
receiving measured sinogram data from one or more scans by a PET scanner, the measured sinogram data representing measured projections from the PET scanner;
iteratively updating pixel values of an emission image until a stopping criterion, comprising:
performing forward rendering to generate a rendered sinogram, wherein performing forward rendering comprises sampling a number of positions corresponding to each crystal detector in a plurality of crystal detectors, the positions defining lines of response (LORs) between crystal pairs; and
performing inverse rendering based on the measured sinogram and the rendered sinogram, wherein performing inverse rendering comprises applying auto-differentiation for gradient-based optimization; and
outputting a reconstructed PET image based on the updated emission image following the stopping criterion being met.
